(19) United States
(12) Patent Application Publication
(10) Pub. No.: US 2026/0163414 A1
(43) Pub. Date: Jun. 11, 2026

(54) STATOR UNIT

(71) Applicant: AISIN CORPORATION, Kariya (JP)

(72) Inventors: Masaki MORI, Kariya-shi (JP); Shota INADA, Kariya-shi (JP)

(73) Assignee: AISIN CORPORATION, Kariya (JP)

(21) Appl. No.: 19/181,667

(22) Filed: Apr. 17, 2025

(30) Foreign Application Priority Data
May 27, 2024 (JP) 2024-085325

(51) Int. Cl. H02K 1/12; H02K 5/04; H02K 11/00

(52) U.S. Cl. CPC H02K 1/12; H02K 5/04; H02K 11/0094

(57) ABSTRACT

A stator unit includes: a neutral line electrically connected to three phases of a stator; and a thermistor fixed to the neutral line and including: a thermistor main body; a temperature measuring portion; and a locking piece having one end connected to the thermistor main body. The neutral line includes a neutral line main body having a folded portion that accommodates the temperature measuring portion and extending along the stator. A locking portion to lock the folded portion together with the thermistor main body or the temperature measuring portion and the locking piece is formed. The folded portion is locked by the locking piece when accommodating therein the temperature measuring portion. When the folded portion is locked, a part of the thermistor main body abuts on the neutral line main body and restricts the thermistor movement in a direction orthogonal to a direction in which the thermistor movement is restricted.

### CROSS REFERENCE TO RELATED APPLICATIONS

This application is based on and claims priority under 35 U.S.C. § 119 to Japanese Patent Application No. 2024-085325, filed on May 27, 2024, the entire content of which is incorporated herein by reference.

### TECHNICAL FIELD

The present disclosure relates to a stator unit.

### BACKGROUND DISCUSSION

When a wire of a thermistor has an exposed portion exposed to the outside, it is necessary to prevent the exposed portion from being in contact with a stator core.

However, in a conventional configuration, it is difficult to position the wire that reaches the detection portion on the end face of the stator core, and the exposed portion may come into contact with the stator core (see JP 2022-142097 A).

In order to solve this issue, JP 2022-142097 A discloses a stator unit including: a stator; a fixing portion fixed to the stator; a thermistor that detects a temperature of the stator; and a holder attached to the fixing portion, wherein a wire of the thermistor has a first portion exposed to the outside and a second portion covered with a tube, and the holder has a hooking portion that hooks the first portion and a holding portion that holds the tube in a state of being folded a plurality of times.

However, in the stator unit disclosed in JP 2022-142097 A, since the thermistor and a neutral line are fixed by the holder that is a component separated from the thermistor, there is a problem that it is necessary to perform a work of disposing the thermistor on the neutral line and fixing the thermistor to the neutral line using the holder in a state of maintaining the disposition, which work takes time and effort.

A need thus exists for a stator unit which is not susceptible to the drawback mentioned above.

### SUMMARY

A stator unit includes: a neutral line electrically connected to a U phase, a V phase, and a W phase of a stator; and a thermistor fixed to the neutral line, the thermistor including: a thermistor main body; a temperature measuring portion; and a locking piece having one end connected to the thermistor main body, wherein the neutral line includes a neutral line main body having a folded portion that accommodates the temperature measuring portion and extending along the stator, a locking portion that locks the folded portion together with the thermistor main body or the temperature measuring portion and the locking piece is formed, the locking portion locks the folded portion when the temperature measuring portion is in a state of being accommodated in the folded portion, and when the folded portion is in a state of being locked by the locking portion, a part of the thermistor main body restricts, by abutting on the neutral line main body, movement of the thermistor in a direction orthogonal to a direction in which movement of the thermistor is restricted by the locking portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a stator unit of a first embodiment according to the present disclosure;

FIG. 2 is a perspective view of a neutral line and a thermistor of the first embodiment according to the present disclosure before the thermistor is fixed to the neutral line;

FIG. 3 is a perspective view illustrating a state in which the thermistor of the first embodiment according to the present disclosure is fixed to the neutral line;

FIG. 4 is a perspective view of a neutral line and a thermistor before the thermistor of a second embodiment according to the present disclosure is fixed to the neutral line; and

FIG. 5 is a perspective view illustrating a state in which the thermistor of the second embodiment according to the present disclosure is fixed to the neutral line.

### DETAILED DESCRIPTION

Hereinafter, with reference to the accompanying drawings, modes for carrying out the present disclosure (hereinafter, referred to as “embodiments”) will be described in detail.

Note that the same elements are denoted by the same numbers or signs throughout the description of the embodiments.

In addition, the dimensional ratios in the drawings are different from actual dimensional ratios, and are merely drawn for easy understanding of the description, and it is not guaranteed that the same portions are drawn with the same dimensions between the drawings.

Furthermore, in the drawings, only a part of a plurality of parts having the same attribute is sometimes denoted by reference signs for ease of viewing.

### First Embodiment

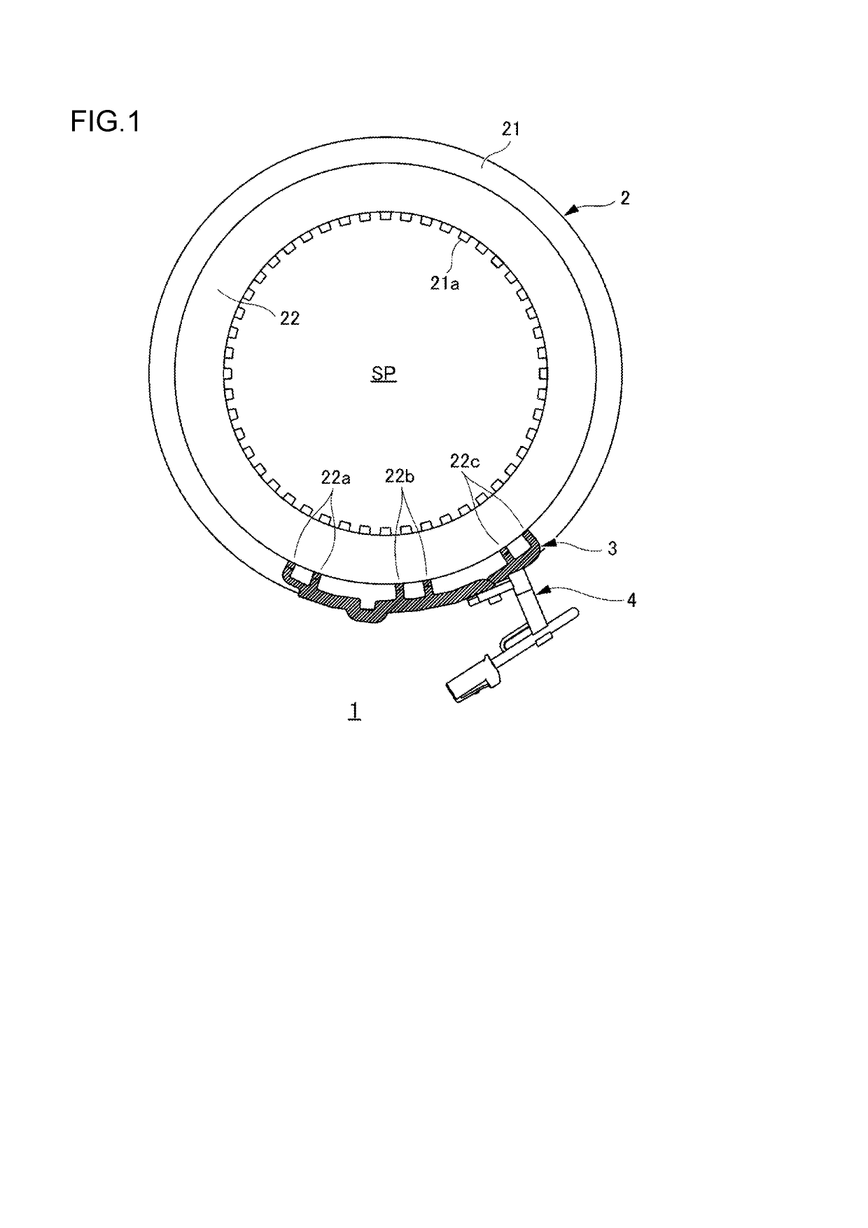

A stator unit 1 of a first embodiment according to the present disclosure will be described with reference to FIGS. 1 to 3.

FIG. 1 is a plan view of the stator unit 1 of the first embodiment according to the present disclosure.

The stator unit 1 includes a stator 2, a neutral line 3, and a thermistor 4, and is used for an inner rotor type motor in which a rotor (not illustrated) is rotatably disposed in a space SP on the radially inner side of the stator 2.

### Stator 2

The stator 2 includes: a stator core 21 having a plurality of teeth 21a provided to be apart from each other at substantially equal intervals in the circumferential direction and protruding inward from an inner peripheral surface; and a coil portion 22 in which a coil wire is wound around the teeth 21a.

The coil portion 22 includes a U-phase coil 22b, a V-phase coil 22c, and a W-phase coil 22a corresponding to three phases of a U phase, a V phase, and a W phase.

In the present embodiment, the coils of the three phases are Y-connected by electrical connection using a neutral line 3, and a double Y-connection is adopted in which two lines of coils are provided for each phase, and each phase is electrically connected to the neutral line 3 at two places.

However, the present invention is not limited thereto, and a single Y connection may be adopted in which one line of coil is provided for each phase, and each phase may be connected to the neutral line 3 at one place.

### Neutral line 3

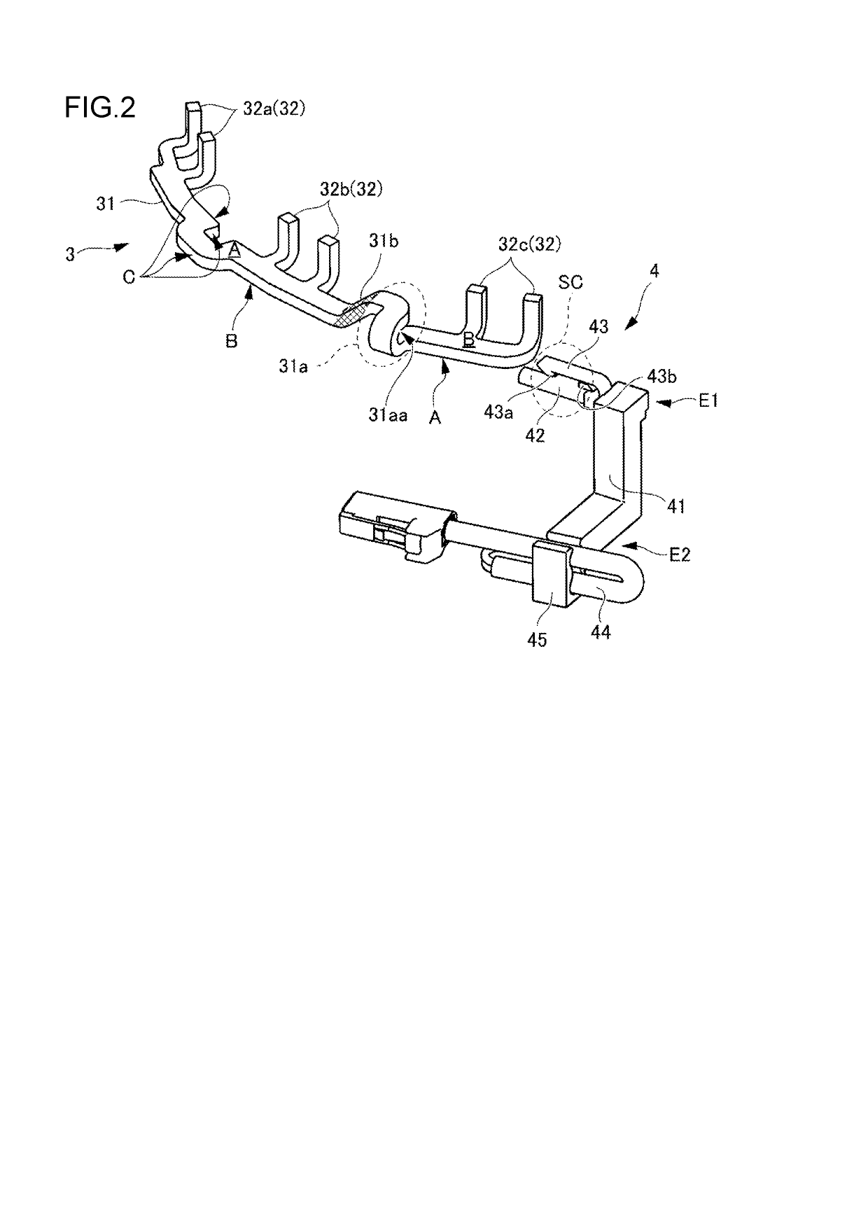

FIG. 2 is a perspective view of the neutral line 3 and the thermistor 4 of the first embodiment according to the present disclosure before the thermistor 4 is fixed to the neutral line 3.

As described above, the neutral line 3 is electrically connected to the U phase (U-phase coil 22b), the V phase (V-phase coil 22c), and the W phase (W-phase coil 22a) of the stator.

As illustrated in FIG. 2, the neutral line 3 includes: a neutral line main body 31 having a folded portion 31a and extending along the stator 2; and electrical connection portions 32 extending from the neutral line main body 31 and each provided corresponding to one of the U phase, the V phase, and the W phase.

Note that a direction extending along the stator 2 may be referred to as an extending direction.

The neutral line main body 31 includes a first surface A that is one surface having a large width, a second surface B that is the other surface having a large width and located on the side opposite to the first surface A, and a side surface C (also referred to as a peripheral surface) having a small width and connecting the first surface A and the second surface B.

The neutral line main body 31 includes an inclined portion 31b connected to one side (the left side in the figure) of the folded portion 31a and having an inclination in which the neutral line main body 31 is displaced further toward the folded portion 31a, in a direction directed from the second surface B toward the first surface A.

The folded portion 31a is folded back so as to detour outside the side surface C of the inclined portion 31b in the outward direction intersecting the extending direction of the neutral line main body 31, so that the first surface A and the second surface B are interchanged with the folded portion 31a interposed therebetween in a plan view as viewed from the side orthogonal to the side surface C (in a plan view in which the first surface A or the second surface B is viewed from the front).

Note that the outward direction intersecting the extending direction of the neutral line main body 31 is a direction toward the radially outer side of the stator 2 when the neutral line 3 is provided on the stator 2 (see FIG. 1), and the same applies hereinafter.

Specifically, in FIG. 2, the first surface A is visible on the inclined portion 31b, and the second surface B located on the opposite side of the first surface A is not visible.

However, at the neutral line main body 31 located on the opposite side of the inclined portion 31b across the folded portion 31a, the second surface B is visible, and in contrast, the first surface A is not visible.

As described above, the folded portion 31a of the present embodiment is folded back such that the facing directions of the first surface A and the second surface B are reversed before and after the folded portion 31a.

Note that, as described above, the folded portion 31a is folded back so as to detour the side surface C of the inclined portion 31b, in the outward direction intersecting the extending direction of the neutral line main body 31.

Therefore, a U-shaped bottom portion 31aa of the folded portion 31a of the neutral line main body 31 is located at a position further outward in the outward direction than the side surface C located on the side of the inclined portion 31b in the outward direction and than the side surface C located on the side opposite to the inclined portion 31b with respect to the folded portion 31a as viewed in the extending direction of the neutral line main body 31.

The folded portion 31a is a folded portion 31a that accommodates a temperature measuring portion 42 of the thermistor 4 to be described later.

On the other hand, the electrical connection portions 32 of the present embodiment includes two U-phase electrical connection portions 32b, two V-phase electrical connection portions 32c, and two W-phase electrical connection portions 32a to accommodate with two coil wires of each of the U phase, the V phase, and the W phase.

Specifically, the U-phase electrical connection portions 32b, the V-phase electrical connection portions 32c, and the W-phase electrical connection portions 32a all extend and are bent by about 90 degrees from the side surface C, of the neutral line main body 31, facing the radially inner side of the stator 2 when the neutral line 3 is provided on the stator 2 (see FIG. 1).

In the case of single Y connection in which one coil is provided for each phase, one U-phase electrical connection portion 32b, one V-phase electrical connection portion 32c, and one W-phase electrical connection portion 32a may be provided.

### Thermistor 4

The thermistor 4 integrally includes a thermistor main body 41, the temperature measuring portion 42 extending laterally from the thermistor main body 41, and a locking piece 43 that has one end connected to the thermistor main body 42 and forms, together with the temperature measuring portion 42, a locking portion SC that locks while sandwiching by the locking piece 43 and the temperature measuring portion 42.

The temperature measuring portion 42 has a portion that corresponds to at least the bottom portion 31aa and is made to conform to the shape of the bottom portion 31aa so that the temperature measuring portion 42 is favorably in contact with the U-shaped bottom portion 31aa of the folded portion 31a of the neutral line main body 31 when the thermistor 4 is in a state of being fixed to the neutral line 3.

In the present embodiment, the temperature measuring portion 42 has a shape that is made to conform to a U-shaped curved surface so that the temperature measuring portion is favorably in contact with the U-shaped bottom portion 31aa.

In order to improve temperature measurement accuracy, the temperature measuring portion 42 is designed to incorporate a temperature measuring element in at a position corresponding to the U-shaped bottom portion 31aa of the folded portion 31a of the neutral line main body 31 when the thermistor 4 is in a state of being fixed to the neutral line 3.

On the other hand, the locking piece 43 extends substantially parallel to the temperature measuring portion 42 from a position that is on an end E1 side of the thermistor main body 41 on the temperature measuring portion 42 side and is closer to the end E1 of the thermistor main body 41 with respect to the temperature measuring portion 42 so as to form the locking portion SC in which the locking piece 43 and the temperature measuring portion 42 locks while sandwiching.

In more detail, in order to form the locking portion SC that locks while sandwiching by the locking piece 43 and the temperature measuring portion 42, the locking piece 43 extends from the side of the thermistor main body 41 substantially parallel to the temperature measuring portion 42 so as to form, from the temperature measuring portion 42, a gap corresponding to the thickness of the neutral line main body 31 (the thickness is the width of the side surface C).

The locking piece 43 includes: a locking claw 43a formed at a tip end of the locking piece 43 and protruding on the temperature measuring portion 42 side; and a protrusion 43b that is provided on the thermistor main body 41 side spaced apart from the locking claw 43a by a distance corresponding to the width of the neutral line main body 31 (the width of the first surface A and the second surface B) and protrudes on the temperature measuring portion 42 side.

Furthermore, in order to improve assemblability, the thermistor 4 includes a holding portion 45 that holds a harness 44 of the thermistor 4 integrally provided on an end E2 side, of the thermistor main body 41, located on the opposite side of the end E1 of the thermistor main body 41 on which the locking piece 43 is provided.

Then, the temperature measuring portion 42 is inserted into the folded portion 31a of the neutral line main body 31, and a part of the folded portion 31a is locked by the locking portion SC formed by the locking piece 43 and the temperature measuring portion 42, whereby the thermistor 4 is fixed to the neutral line 3.

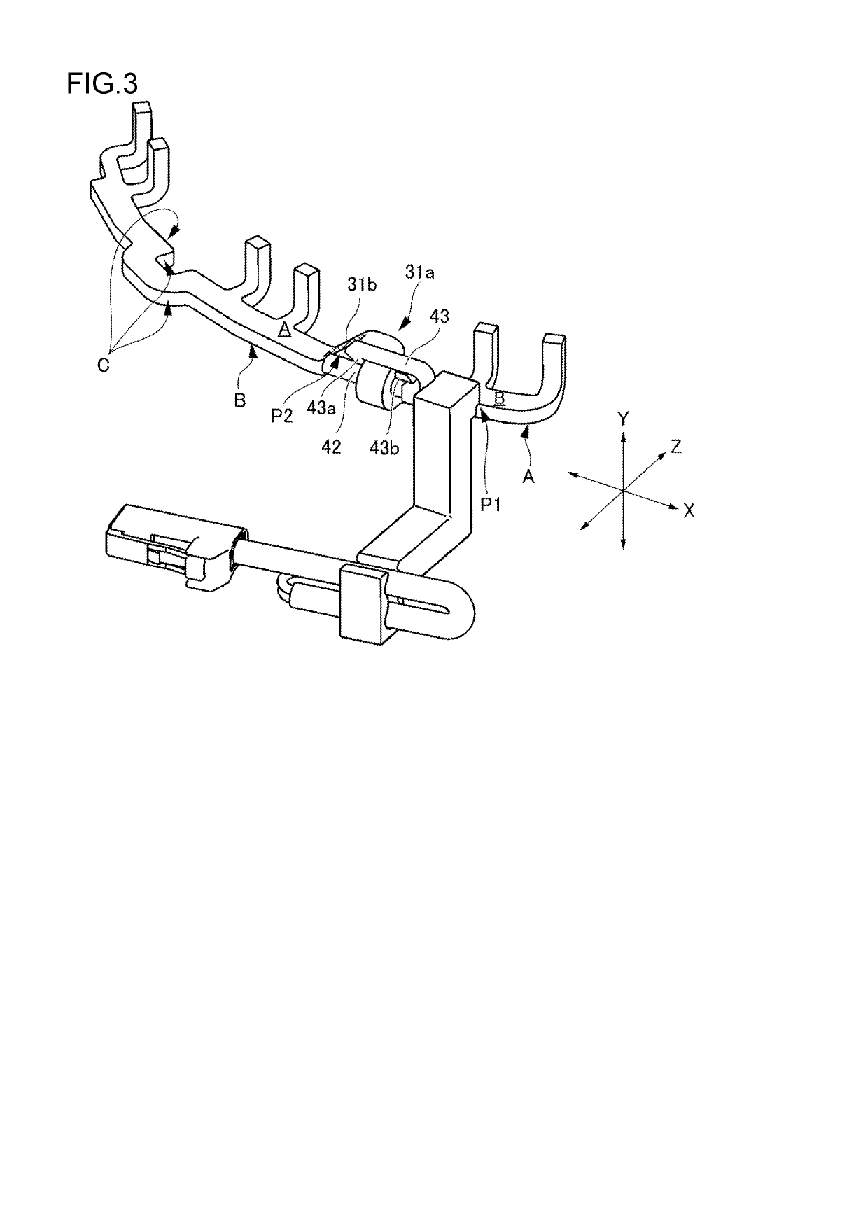

FIG. 3 is a perspective view illustrating a state in which the thermistor 4 of the first embodiment according to the present disclosure is fixed to the neutral line 3.

As illustrated in FIG. 3, the locking portion SC (see FIG. 2) locks the side surface C of the folded portion 31a by the locking claw 43a of the locking piece 43 and prevents the side surface C from coming off when the temperature measuring portion 42 is in a state of being accommodated in the folded portion 31a.

At this time, a part of the neutral line main body 31 forming the folded portion 31a is fitted between the locking claw 43a and the protrusion 43b formed on the locking piece 43 of the locking portion SC, so that movement of the thermistor 4 with respect to the neutral line main body 31 in an insertion and removal direction (also referred to as a first direction X) of the locking portion SC is restricted.

In addition, since the locking portion SC locks while sandwiching a portion of the neutral line main body 31 forming the folded portion 31a by the temperature measuring portion 42 and the locking piece 43, so that the movement of the thermistor 4 with respect to the neutral line main body 31 in the sandwiching direction (also referred to as a second direction Y) orthogonal to the insertion and removal direction of the locking portion SC is restricted.

As described above, when the locking portion SC is in a state of locking the folded portion 31a, the movement of the thermistor 4 with respect to the neutral line main body 31 in the first direction X and the second direction Y is restricted by the locking portion SC as illustrated in FIG. 3.

Furthermore, when the locking portion SC is in a state of locking the folded portion 31a, a part P1 of the thermistor main body 41 restricts, by abutting on the side surface C of the neutral line main body 31, movement in the direction (also referred to as a third direction Z) orthogonal to the directions (first direction X and second direction Y) in which movement is restricted by the locking portion SC, more specifically, the movement toward the opening side located on the side opposite to the U-shaped bottom portion 31aa of the folded portion 31a (see FIG. 2).

Specifically, when the locking portion SC is in a state of locking the folded portion 31a, the side surface C of the neutral line main body 31 on which the part P1 of the thermistor main body 41 abuts is the side surface C located on the side opposite to the inclined portion 31b with respect to the folded portion 31a as viewed in the extending direction of the neutral line main body 31.

In other words, when the locking portion SC is in a state of locking the folded portion 31a, the side surface C of the neutral line main body 31 on which the part P1 of the thermistor main body 41 abuts is the side surface C that is located on the side opposite to the inclined portion 31b with respect to the folded portion 31a as viewed in the extending direction of the neutral line main body 31 and is located on the U-shaped bottom portion 31aa side of the folded portion 31a of the neutral line main body 31.

As described above, when the thermistor 4 of the present embodiment is fixed to the neutral line 3 by the locking portion SC, the movement in the three-dimensional direction (first direction X, second direction Y, and third direction Z) is restricted, and the thermistor 4 is stably fixed to the neutral line 3.

In addition, in the present embodiment, when the locking portion SC is in a state of locking the folded portion 31a, the movement in the direction (third direction Z) orthogonal to the directions (first direction X and second direction Y) in which the movement is restricted by the locking portion SC is restricted also by the temperature measuring portion 42 abutting on the side surface C of the neutral line main body 31 at a position P2 on the inclined portion 31b; therefore, the thermistor 4 is more stably fixed to the neutral line 3.

Note that the side surface C that is of the neutral line main body 31 at the position P2 on the inclined portion 31b and on which the temperature measuring portion 42 abuts is also the side surface C located on the U-shaped bottom portion 31aa side of the folded portion 31a of the neutral line main body 31.

As described above, in the first embodiment, the fixing can be performed by a simple work in which the folded portion 31a of the neutral line main body 31 is sandwiched by the locking portion SC, and the movement of the fixed thermistor 4 in the first direction X, the second direction Y, and the third direction Z is restricted, so that a stable fixing state is achieved.

### Second embodiment

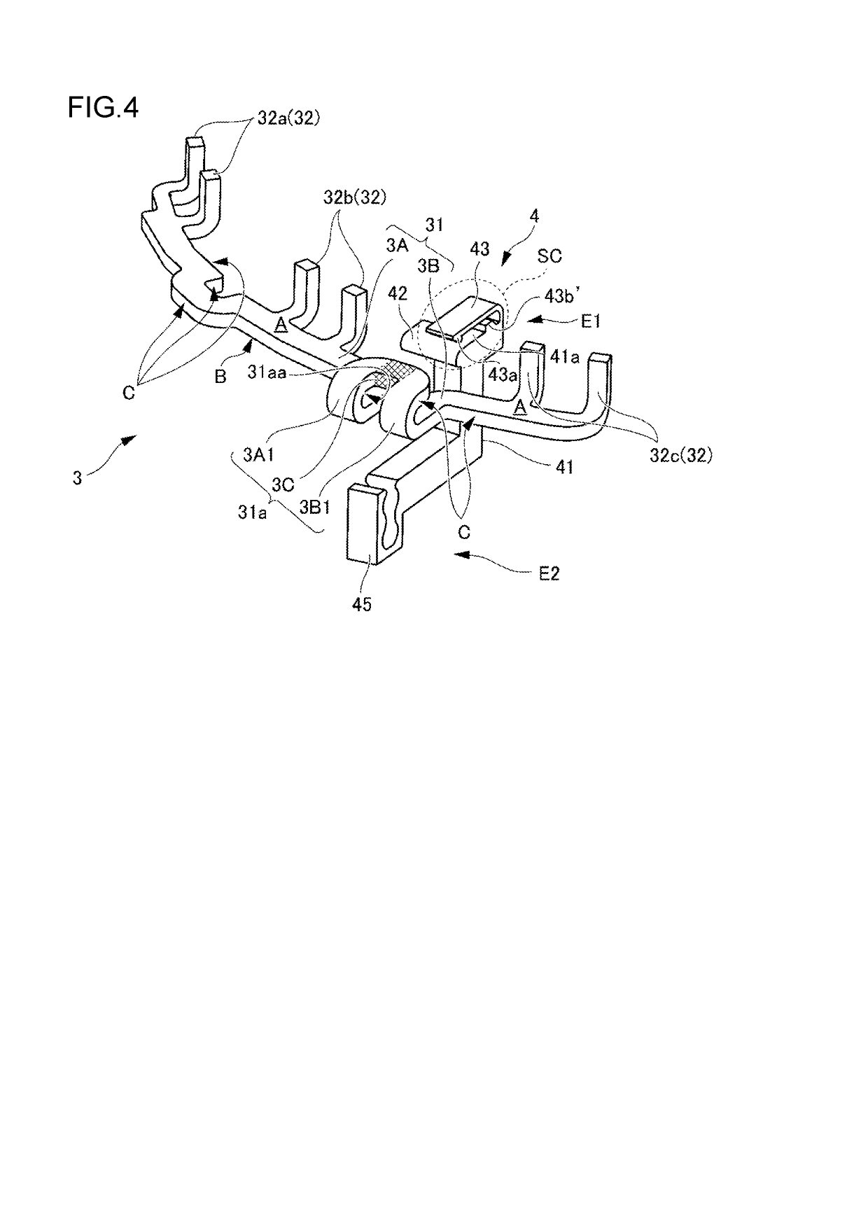

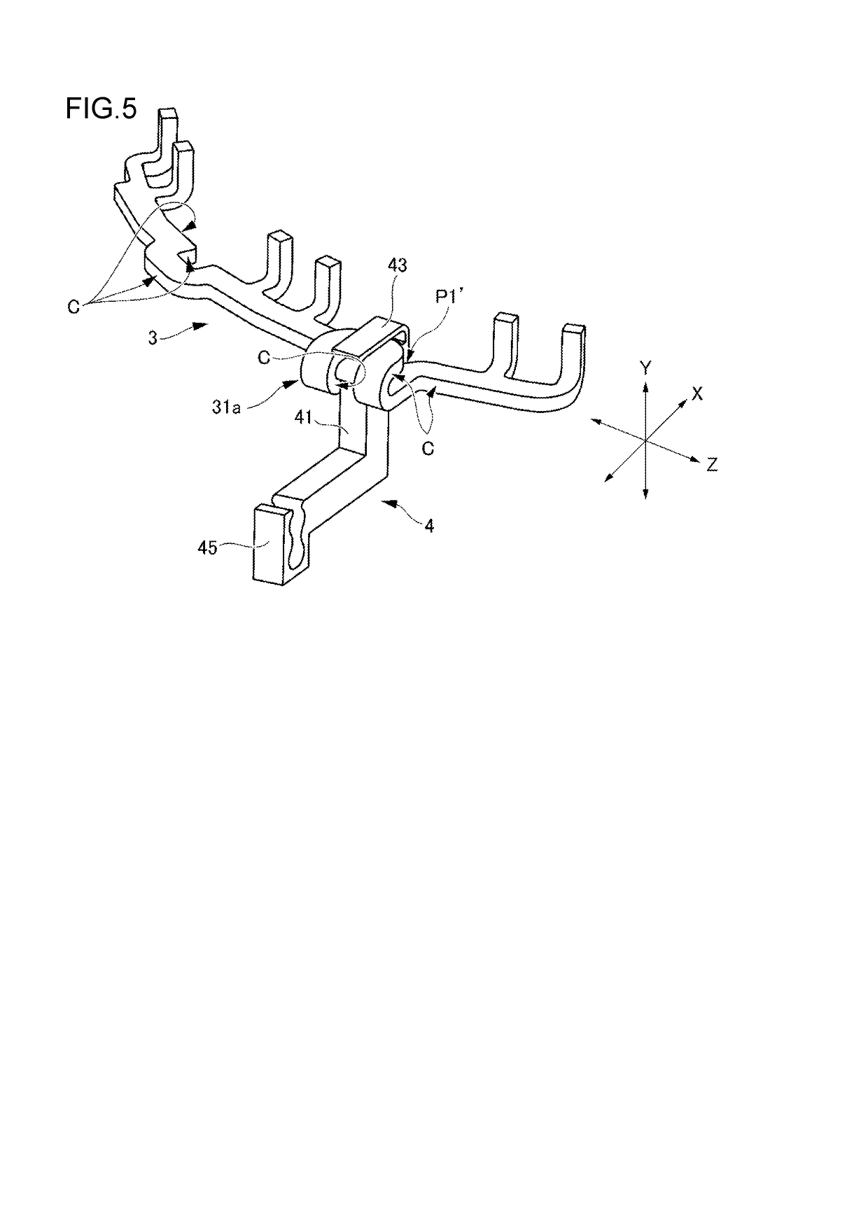

A stator unit 1 of a second embodiment according to the present disclosure will be described with reference to FIGS. 4 and 5.

FIG. 4 is a perspective view of a neutral line 3 and a thermistor 4 of the second embodiment according to the present disclosure before the thermistor 4 is fixed to the neutral line 3.

Hereinafter, the stator unit 1 of the second embodiment will be specifically described, but a stator 2 (not illustrated) is similar to that in the first embodiment, and also regarding the neutral line 3 and the thermistor 4, a description of points similar to those in the first embodiment may be omitted.

### Neutral line 3

A part of the neutral line 3 of the second embodiment is different with reference to the neutral line main body 31, and the neutral line main body 31 will be described below.

As illustrated in FIG. 4, the neutral line main body 31 of the second embodiment includes: a first main body 3A; and a second main body 3B connected to the first main body 3A via a part of a folded portion 31a and separated from the first main body 3A.

The folded portion 31a includes: a first bent portion 3A1 that extends in the outward direction from a side surface C, of the first main body 3A, on the side closer to the second main body 3B and is then folded back; a second bent portion 3B1 that extends in the outward direction from a side surface C, of the second main body 3B, on the side closer to the first main body 3A and is then folded back; and a connecting portion 3C that connects a tip end side of the first bent portion 3A1 and a tip end side of the second bent portion 3B1 so as to connect the first main body 3A and the second main body 3B.

Note that the outward direction in the present embodiment is also similar to the outward direction in the first embodiment (the outward direction intersecting the extending direction of the neutral line main body 31) and is a direction toward the radially outer side of the stator 2 when the neutral line 3 is provided on the stator 2 (see FIG. 1).

The folded portion 31a is configured as described above; therefore, unlike the first embodiment, the folded portion 31a is folded back such that the directions in which the first surface A and the second surface B are directed are not exchanged before and after the folded portion 31a as viewed in the extending direction of the neutral line main body 31, so that the folding is easy to process.

### Thermistor 4

Similarly to the first embodiment, the thermistor 4 includes a temperature measuring portion 42 extending laterally from a thermistor main body 41, and the temperature measuring portion 42 is formed in a shape made to conform to a U-shape of the folded portion 31a of the neutral line main body 31.

More precisely, the temperature measuring portion 42 is formed to have a shape made to conform to the U-shape inside the first bent portion 3A1.

Furthermore, there is a difference in that a locking piece 43 extends from an end E1 of the thermistor main body 41 so as to cover an end face 41a, of the thermistor main body 41, on the temperature measuring portion 42 side while being separated from the end face 41a of the thermistor main body 41 so that the locking portion SC is formed in which the locking piece 43 and the thermistor main body 41 locks while sandwiching.

In more detail, in order to form the locking portion SC in which the locking piece 43 and an end face 41a of the thermistor main body 41 locks while sandwiching, the locking piece 43 extends substantially parallel to the end face 41a of the thermistor main body 41 from the end E1 of the thermistor main body 41 so as to form, from the end face 41a of the thermistor main body 41, a gap corresponding to the thickness (the width of the side surface C) of the neutral line main body 31.

Furthermore, in the first embodiment, the protrusion 43b is formed on the locking piece 43; however, in the second embodiment, a protrusion 43b’ protruding on the locking piece 43 side is provided on the end face 41a of the thermistor main body 41 that is separated from the locking claw 43a of the locking piece 43 by a distance corresponding to the width (the width of the first surface A and the second surface B) of the neutral line main body 31.

Furthermore, the width of the thermistor main body 41 is designed to be substantially equal to the separation distance between the first main body 3A and the second main body 3B.

The temperature measuring portion 42 is inserted into the folded portion 31a (more precisely, the first bent portion 3A1) from the U-shaped opening side of the folded portion 31a, and a part (more specifically, the connecting portion 3C) of the folded portion 31a is locked by the locking portion SC formed by the locking piece 43 and the end face 41a of the thermistor main body 41, whereby the thermistor 4 is fixed to the neutral line 3.

FIG. 5 is a perspective view illustrating a state in which the thermistor 4 of the second embodiment according to the present disclosure is fixed to the neutral line 3.

Note that, in FIG. 5, since there are many parts that cannot be seen due to locking, and there are many parts that cannot be assigned signs or numbers; therefore, basically refer to FIG. 4 for signs and numbers.

As illustrated in FIG. 5, the locking portion SC locks the side surface C of the folded portion 31a (the side surface C located in the outward direction of the connecting portion 3C) by the locking claw 43a of the locking piece 43 and prevents the side surface C from coming off when the temperature measuring portion 42 is in a state of being accommodated in the folded portion 31a.

At this time, a part of the neutral line main body 31 forming the folded portion 31a (more specifically, the part is the connecting portion 3C) is fitted between the locking claw 43a formed on the locking piece 43 of the locking portion SC and the protrusion 43b’ formed on the end face 41a of the thermistor main body 41, and the movement of the thermistor 4 with respect to the neutral line main body 31 in an insertion and removal direction of the locking portion SC (also referred to as a first direction X) is restricted similarly to the first embodiment.

In addition, since the locking portion SC locks while sandwiching a part of the neutral line main body 31 forming the folded portion 31a (in more detail, the part is the connecting portion 3C) by the end face 41a of the thermistor main body 41 and the locking piece 43, so that, similarly to the first embodiment, the movement of the thermistor 4 with respect to the neutral line main body 31 in the sandwiching direction (also referred to as a second direction Y) orthogonal to the insertion and removal direction of the locking portion SC is restricted.

Therefore, also in the second embodiment, similarly to the first embodiment, when the locking portion SC is in a state of locking the folded portion 31a, the movement of the thermistor 4 with respect to the neutral line main body 31 in the first direction X and the second direction Y is restricted by the locking portion SC as illustrated in FIG. 5.

Furthermore, when the locking portion SC is in a state of locking the folded portion 31a (in more detail, the connecting portion 3C), a part P1’ of the thermistor main body 41 restricts, by abutting on the side surface C of the neutral line main body 31, movement in the direction (also referred to as a third direction Z) orthogonal to the directions (first direction X and second direction Y) in which the movement is restricted by the locking portion SC.

More specifically, when the locking portion SC is in a state of locking the folded portion 31a (in more detail, the connecting portion 3C), the part P1’ of the thermistor main body 41 close to the temperature measuring portion 42 is fitted in a gap that separates the first main body 3A and the second main body 3B from each other, and the width of the thermistor main body 41 is designed to be substantially equal to the separation distance between the first main body 3A and the second main body 3B as described above.

Therefore, the part P1’ of the thermistor main body 41 close to the temperature measuring portion 42 abuts on the opposed side surfaces C of the first main body 3A and the second main body 3B, so that, similarly to the first embodiment, the movement in the direction (also referred to as the third direction Z) orthogonal to the directions (first direction X and second direction Y) in which the movement is restricted by the locking portion SC is restricted.

Furthermore, in the present embodiment, when the thermistor 4 is fixed to the neutral line 3 by the locking portion SC, the movement in the three-dimensional direction (first direction X, second direction Y, and third direction Z) is restricted, and the thermistor 4 is stably fixed to the neutral line 3.

As described above, with the first embodiment and the second embodiment, there is no need for a separate component to fix the thermistor 4 to the neutral line 3, and it is possible to fix the thermistor 4 to the neutral line 3 in a stable state by a simple work with less labor in which the locking portion SC of the thermistor 4 is made to lock the neutral line 3.

In addition, since the holding portion 45 for integrally holding the harness 44 of the thermistor 4 is also formed, the number of components is small, and cost can be reduced.

Although the present disclosure has been described above on the basis of specific embodiments, the present disclosure is not limited to the above-described embodiments, and modifications and improvements to the embodiments are also included in the technical scope of the disclosure, and this is apparent to those skilled in the art from the description of the claims.

A stator unit includes: a neutral line electrically connected to a U phase, a V phase, and a W phase of a stator; and a thermistor fixed to the neutral line, the thermistor including: a thermistor main body; a temperature measuring portion; and a locking piece having one end connected to the thermistor main body, wherein the neutral line includes a neutral line main body having a folded portion that accommodates the temperature measuring portion and extending along the stator, a locking portion that locks the folded portion together with the thermistor main body or the temperature measuring portion and the locking piece is formed, the locking portion locks the folded portion when the temperature measuring portion is in a state of being accommodated in the folded portion, and when the folded portion is in a state of being locked by the locking portion, a part of the thermistor main body restricts, by abutting on the neutral line main body, movement of the thermistor in a direction orthogonal to a direction in which movement of the thermistor is restricted by the locking portion.

With the above configuration, it is possible to provide the stator unit including the thermistor that does not require a separate component in fixing the thermistor to the neutral line and can be fixed to the neutral line in a stable state.

In the stator unit, the locking piece extends from a portion, of the thermistor main body, on the temperature measuring portion side to form a locking portion in which the locking piece locks while sandwiching together with the temperature measuring portion, the neutral line main body includes an inclined portion connected to one side of the folded portion and having an inclination toward the folded portion, and when the locking portion is in a state of locking the folded portion, the movement of the thermistor in a direction orthogonal to a direction in which movement of the thermistor is restricted by the locking portion is restricted by the temperature measuring portion abutting on the neutral line main body at a position on the inclined portion.

In the stator unit, the neutral line main body includes: a first main body; and a second main body that is connected to the first main body via a part of the folded portion and is separated from the first main body, wherein the folded portion includes: a first bent portion that extends in an outward direction from a side surface, of the first main body, closer to the second main body and is then folded back, a second bent portion that extends in an outward direction from a side surface, of the second main body, closer to the first main body and is then folded back, a connecting portion that connects a tip end side of the first bent portion and a tip end side of the second bent portion to connect the first main body and the second main body, and the locking portion locks the connecting portion of the folded portion.

In the stator unit, the thermistor includes a holding portion that holds a harness of the thermistor and is integrally provided on an end side, of the thermistor main body, located on an opposite side of an end of the thermistor main body on which the locking piece is provided.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A stator unit comprising:
a neutral line electrically connected to a U phase, a V phase, and a W phase of a stator; and
a thermistor fixed to the neutral line, the thermistor including:
a thermistor main body;
a temperature measuring portion; and
a locking piece having one end connected to the thermistor main body,
wherein the neutral line includes a neutral line main body having a folded portion that accommodates the temperature measuring portion and extending along the stator,
a locking portion that locks the folded portion together with the thermistor main body or the temperature measuring portion and the locking piece is formed,
the locking portion locks the folded portion when the temperature measuring portion is in a state of being accommodated in the folded portion, and
when the folded portion is in a state of being locked by the locking portion, a part of the thermistor main body restricts, by abutting on the neutral line main body, movement of the thermistor in a direction orthogonal to a direction in which movement of the thermistor is restricted by the locking portion.

2. The stator unit according to claim 1, wherein the locking piece extends from a portion, of the thermistor main body, on the temperature measuring portion side to form a locking portion in which the locking piece locks while sandwiching together with the temperature measuring portion,
the neutral line main body includes an inclined portion connected to one side of the folded portion and having an inclination toward the folded portion, and
when the locking portion is in a state of locking the folded portion, the movement of the thermistor in a direction orthogonal to a direction in which movement of the thermistor is restricted by the locking portion is restricted by the temperature measuring portion abutting on the neutral line main body at a position on the inclined portion.

3. The stator unit according to claim 1, wherein the neutral line main body includes:
a first main body; and
a second main body that is connected to the first main body via a part of the folded portion and is separated from the first main body,
the folded portion includes:
a first bent portion that extends in an outward direction from a side surface, of the first main body, closer to the second main body and is then folded back,
a second bent portion that extends in an outward direction from a side surface, of the second main body, closer to the first main body and is then folded back,
a connecting portion that connects a tip end side of the first bent portion and a tip end side of the second bent portion to connect the first main body and the second main body, and
the locking portion locks the connecting portion of the folded portion.

4. The stator unit according to claim 1, wherein the thermistor includes a holding portion that holds a harness of the thermistor and is integrally provided on an end side, of the thermistor main body, located on an opposite side of an end of the thermistor main body on which the locking piece is provided.

5. The stator unit according to claim 2, wherein the thermistor includes a holding portion that holds a harness of the thermistor and is integrally provided on an end side, of the thermistor main body, located on an opposite side of an end of the thermistor main body on which the locking piece is provided.

6. The stator unit according to claim 3, wherein the thermistor includes a holding portion that holds a harness of the thermistor and is integrally provided on an end side, of the thermistor main body, located on an opposite side of an end of the thermistor main body on which the locking piece is provided.
